(19) United States
(12) Patent Application Publication
(10) Pub. No.: US 2024/0423235 A1
(43) Pub. Date: Dec. 26, 2024

(54) Ice Cream Maker

(71) Applicant: Gregory Savage, Toccoa, GA (US)

(72) Inventor: Gregory Savage, Toccoa, GA (US)

(21) Appl. No.: 18/750,502

(22) Filed: Jun. 21, 2024

Related U.S. Application Data
(60) Provisional application No. 63/522,806, filed on Jun. 23, 2023.

(51) Int. Cl. A23G 9/08; B65D 43/02; B65D 51/24; B65D 81/38; B65D 85/78

(52) U.S. Cl. CPC A23G 9/08; B65D 43/0229; B65D 51/248; B65D 81/3841; B65D 85/78

(57) ABSTRACT

An ice cream maker designed to keep cans and bottles secure while consistently cooling them with ice. An upper lid includes a flange with an opening for receiving a food product container within the interior volume, such that the top end of the food product container is exposed for consumption. The upper lid has a solid connector that allows for a straw or a spout to be connected to the opening of a food product container that sits within the interior volume of the holder. The perimeter wall includes an interior layer and an exterior layer defining an interior channel surrounding the main interior volume, which is only accessible via the lower lid. The interior channel is filled with a freezable material, which includes salt or other materials to lower the freezing point temperature.

### CROSS-REFERENCE TO RELATED APPLICATIONS

This is a U.S. Non-Provisional patent application that claims the benefit of co-pending U.S. Provisional Patent Application No. 63/522,806 filed Jun. 23, 2023, which is incorporated herein by reference in its entirety.

### BACKGROUND OF THE INVENTION

The present disclosure relates to a container and, more particularly, to an ice cream maker.

People enjoy consuming a cold food product, whether that be a cold drink, a yogurt, or an ice cream. Unfortunately, as a person consumes the cold food product, the temperature of the food product rises. This may lead to the food product being less desirable if the individual does not consume it in an appropriate amount of time. There are multiple ways available to allow a cold food product to maintain a desired temperature. The current methods of maintaining a cold food product's desired cool temperature for long periods of time requires ice and/or an insulated sleeve that covers a beverage or KOOZIE®. When using ice to prolong a cold temperature of a food product, it is inevitable that the ice will melt. The melting of the ice causes the food product to become diluted because of the water being added to the food product. The diluting that ice causes may ultimately ruin the taste of the food product. Alternatively, KOOZIES® may be an effective means to maintain a cold temperature for some of the food products. However, the KOOZIES® may not provide a complete insulation to the food product and still leave some of the residual food product to become warm while the person is consuming the food product. This warming of the food product may make it undesirable to consume.

Accordingly, a need remains to provide persons with an ice cream maker designed to keep food products secure while consistently cooling them with ice.

### SUMMARY OF THE INVENTION

The present disclosure relates to a food holder and, more particularly, to an ice cream maker.

The insulated food holder includes an open upper end and an closed lower end, an opening disposed on the open upper end a threaded lid disposed on the top of the open upper end, a perimeter wall disposed between the open upper end and the closed lower end, the perimeter wall define an interior volume, and an upper lid having a solid connector, the solid connector permits a straw or a spout to be extended through the opening of a food product container when the food product container is placed within the interior volume of the ice cream maker.

It is an object of the present invention to provide an ice cream maker that makes ice cream

It is an object of the present invention to provide an ice cream maker to contain a cold food product that includes a cold drink.

It is an object of the present invention to provide an ice cream maker to contain a cold food product that includes a yogurt.

It is an object of the present invention to provide an ice cream maker to contain a cold food product that includes an ice cream.

### BRIEF DESCRIPTION OF DRAWINGS

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 shows a front perspective view of an embodiment of an ice cream maker.

FIG. 2 shows an exploded front perspective view of an embodiment of the ice cream maker.

FIG. 3 shows a front perspective view of an embodiment of the ice cream maker in use.

FIG. 4 shows a bottom perspective view of an embodiment of the ice cream maker.

### DETAILED DESCRIPTION OF THE INVENTION

The non-limiting exemplary embodiment(s) will now be described more fully hereinafter with reference to the accompanying drawings, in which a preferred embodiment of the disclosure is shown. Such exemplary embodiment(s) may, however, be embodied in many different forms and should not be construed as limited to the embodiment set forth herein. Rather, these embodiment(s) are provided so that this application will be thorough and complete, and will fully convey the true scope of the disclosure to those skilled in the art.

The below disclosed subject matter is to be considered illustrative, and not restrictive, and any appended claim(s) are intended to cover all such modifications, enhancements, and other embodiment(s) which fall within the true scope of the non-limiting exemplary embodiment(s). Thus, to the maximum extent allowed by law, the scope of the non-limiting exemplary embodiment(s) is to be determined by the broadest permissible interpretation of the claim(s) and their equivalents, and shall not be restricted or limited by the foregoing detailed description.

References in the specification to “an exemplary embodiment”, “an embodiment”, “a preferred embodiment”, “an alternative embodiment”, and similar phrases mean that a particular feature, structure, or characteristic described in connection with the embodiment(s) is included in at least an embodiment of the disclosure. The appearances of the phrase “a non-limiting exemplary embodiment” in various places in the specification are not necessarily all meant to refer to the same embodiment.

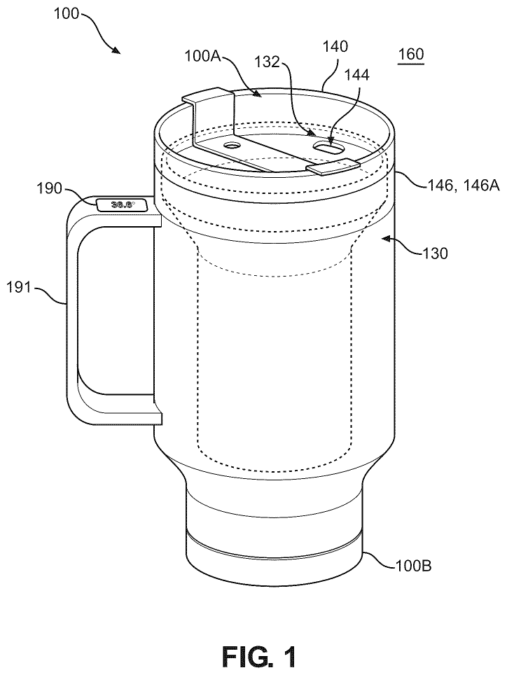

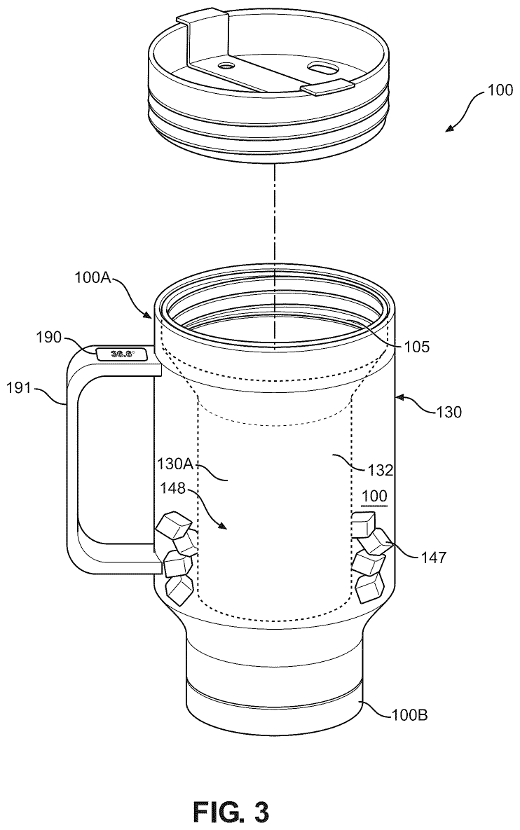

Referring now to FIGS. 1 and 3, there are shown perspective views of an embodiment of an ice cream maker 100.

The ice cream maker 100 may include an open upper end 100A and a closed lower end 100B. The closed lower end 100B and the open upper end 100A may be on opposing ends of the ice cream maker 100. The open upper end 100A can include an opening 144. The closed lower end 100B may include a perimeter wall 130. The perimeter wall 130 may extend upwardly from the closed lower end 100B. The perimeter wall 130 may taper inwardly or outwardly toward the open upper end 100A and the closed lower ends 100B. The open upper end 100A may include a threaded lid 140. The open upper end 100A may include a gasket 105 disposed on the open upper end 100A to prevent spilling. The closed lower end 100B, the open upper end 100A, and the perimeter wall 130 may define an interior volume 132. The threaded lid 140 may include an opening 144. The opening 144 may permit a straw, a spout, or the like to be extended through the opening of a threaded lid 140 when the food product container 146 may be placed within the interior volume 132 of the ice cream maker 100 whereby a top end 146A of the food product container 146 may be exposed for consumption through the open upper end 100A of the ice cream maker 100. The food product container 146 may contain a plurality of ice cream, a cold beverage, or the like.

The perimeter wall 130 may include a removable interior layer 130A and an exterior layer 130B. The removable interior layer 130A and the exterior layer 130B of the perimeter wall 130 may define an interior channel 148. The interior channel 148 may surround the interior volume 132. The interior volume 132 may be accessible via the threaded lid 140. The interior channel 148 may be filled with a freezable material 147 or the like. Moreover, a user may place water therein and may include salt or the like to lower the freezing point temperature or the like. The food product container 146 may be surrounded by the freezable material 147 or other coolant or the like to allow a food product disposed within the food product container 146 to reach and remain at a desired temperature.

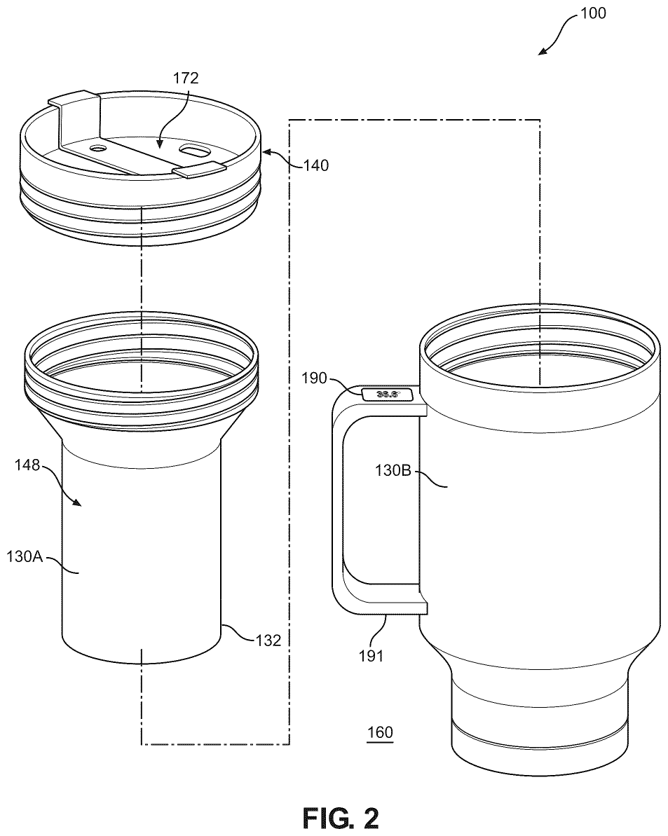

Referring now to FIG. 2, there is shown an exploded view of an embodiment of an ice cream maker 100.

The ice cream maker 100 may include the threaded lid 140 that may also have a solid connector 172. The solid connector 172 may permit a straw, a spout, or the like to be extended through the opening of a food product container when the food product container 146 may be placed within the interior volume 132 of the ice cream maker 100. In one embodiment, a sliding mechanism 180 may be disposed on the threaded lid 140 that reveals the opening or spout. Moreover, an internal thermometer 190 may be disposed on the threaded lid 140. The internal thermometer 190 may provide a temperature reading of the food product placed therein. This will allow the user to be aware of the temperature of the food product to determine if the desired temperature of the food product is being achieved or the like.

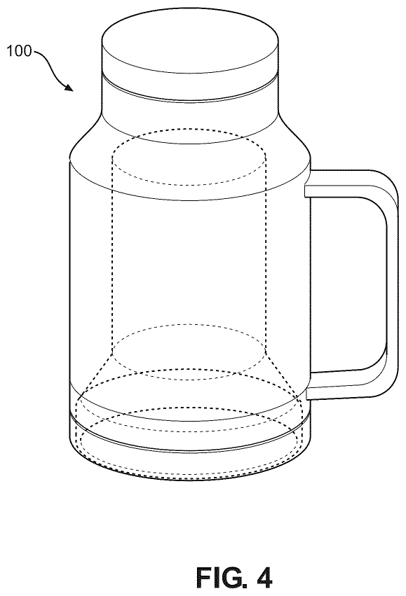

Referring now to FIG. 4, there is shown a bottom up perspective view of an embodiment of an ice cream maker 100. An internal thermometer 190 may be disposed on the handle 191. The internal thermometer 190 may provide a temperature reading of the food product placed therein. This will allow the user to be aware of the temperature of the food product to determine if the desired temperature of the food product is being achieved or the like. In use, the user will place the ice cream maker 100 with a food product container 146 in place within the internal volume 132 through the opening at the threaded lid 140. The threaded lid 140 may secure the food product therein, via a threaded interface 172. The freezable material 147 or other coolant is placed within the internal channel 146 via the opening of the threaded lid 140. The freezable material 147 will encase the food product container 146. The lower lid 150 will be secured to encase the freezable material 147 in the internal channel 146, via the threaded interface 172.

The foregoing descriptions of specific embodiments of the present invention have been presented for purposes of illustration and description. They are not intended to be exhaustive or to limit the present invention to the precise forms disclosed, and obviously many modifications and variations are possible considering the above teaching. The exemplary embodiment was chosen and described to best explain the principles of the present invention and its practical application, to thereby enable others skilled in the art to best utilize the present invention and various embodiments with various modifications as are suited to the particular use contemplated.

What is claimed as new is:

1. An ice cream maker, comprising:
an open upper end and a closed lower end;
an opening disposed on the open upper end;
a perimeter wall disposed on between the open upper end and the closed lower end;
a threaded lid disposed on the open upper end;
wherein the closed lower end, the open upper end, and the perimeter wall define an interior volume;
wherein the threaded lid having a solid connector, the solid connector is adapted to permit a straw or a spout to be extended through the opening of a food product container when the food product container is placed within the interior volume of the ice cream maker;
wherein the open upper end includes a gasket disposed on the open upper end to prevent spilling; and
wherein the closed lower end is secured to encase a freezable material in the internal channel.

2. The ice cream maker, according to claim 1, wherein the perimeter wall tapers inwardly toward the open upper end and the closed lower ends.

3. The ice cream maker, according to claim 1, wherein the perimeter wall extends upwardly from the closed lower end.

4. The ice cream maker, according to claim 1, wherein the perimeter wall includes an interior layer and an exterior layer that defines an interior channel.

5. The ice cream maker, according to claim 4, wherein the interior channel that surrounds the interior volume is accessible via the open upper end.

6. The ice cream maker, according to claim 1, wherein the opening is adapted to receive the food product container within the interior volume.

7. The ice cream maker, according to claim 6, wherein a top end of the food product container is exposed for consumption through the open upper end of the ice cream maker.

8. The ice cream maker, according to claim 1, wherein the food product container is surrounded by the freezable material to allow a cold food product disposed within the food product container to remain at a desired temperature.

9. The ice cream maker, according to claim 8, wherein the cold food product is an ice cream.

10. The ice cream maker, according to claim 8, wherein the cold food product is a cold beverage.

11. The ice cream maker, according to claim 1, wherein the freezable material includes water and salt to lower the freezing point temperature.

12. The ice cream maker, according to claim 1, wherein the freezable material is placed within the internal channel via the opening of the open upper end and encase the food product container.

13. The ice cream maker, according to claim 1, wherein the freezable material will encase the food product container.

14. The ice cream maker, according to claim 1, wherein the closed lower end. is secured to encase the freezable material in the internal channel.

15. The ice cream maker, according to claim 1, further comprising a sliding mechanism is disposed on the upper lid that reveals the opening.

16. The ice cream maker, according to claim 1, further comprising an internal thermometer is disposed on the upper handle and provides a temperature reading of the food product placed therein.

17. The ice cream maker, according to claim 1, wherein the ice cream maker with the food product container is placed within the internal volume through the opening at the upper lid.

18. The ice cream maker, according to claim 1, wherein the upper lid secures the food product therein, via a threaded interface.
